(19) United States
(12) Patent Application Publication
(10) Pub. No.: US 2012/0326428 A1
(43) Pub. Date: Dec. 27, 2012

(54) TOY ANIMAL CONFIGURABLE FOR USE AS BOOKMARK

(76) Inventors: John STONES, Carlsbad, CA (US); Denise Kovac, Carlsbad, CA (US)

(21) Appl. No.: 13/188,267

(22) Filed: Jul. 21, 2011

Related U.S. Application Data
(60) Provisional application No. 61/501,717, filed on Jun. 27, 2011.

(51) Int. Cl. B42D 9/00; A63H 3/00

(52) U.S. Cl. 281/42; 446/72

(57) ABSTRACT

A combination of a book and bookmark includes a book and a bookmark indicating a location between adjacent pages of the book. The bookmark includes a top portion of a toy animal, a bottom portion of a toy animal, and a connecting portion that extends in-between the adjacent pages of the book and joins the top portion and the bottom portion and maintains the top portion in tensioned abutment with a first side of the book and maintains the bottom portion in tensioned abutment with a second, opposite side of the book,

### CROSS-REFERENCE TO RELATED APPLICATION

The present application is a nonprovisional patent application of, and claim the benefit under 35 U.S.C. 119(e) to, provisional patent application 61/501,717 filed Jun. 27, 2011, the disclosure of which provisional patent application is incorporated by reference herein. Additionally, the Appendix includes a copy of the disclosure of the provisional application, which is hereby incorporated herein by reference.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

Exemplary plush bookmarks of the prior art are shown in FIG. 37. In each of these bookmarks, a plush head portion of a stuffed toy animal is connected by a length of fabric to a plush foot portion corresponding to the stuffed toy animal. The length of fabric is generally wide and thin, and comprises a flexible, inelastic fabric band. One end of the band is fixed to the head portion and the other end is fixed to the foot portion. The band is not retractable and there is no configuration of the bookmark in which the top and bottom portions come together and remain together for use of the plush bookmark as a conventional stuffed toy animal. Nor is there any portion that comprises part of the body of a conventional stuffed animal between the head portion and foot portion; the head portion consists of the head, and the foot potion consists of two feet joined together in an inverted “v”. The animals represented in FIG. 37 include a giraffe, an elephant, a lion, a zebra, a bear, and a tiger. Accordingly, it is believed that plush bookmarks of the prior art are in need of improvement. This need is addressed by one or more aspects or features of the present invention.

### SUMMARY OF THE INVENTION

The present invention includes many aspects and features. Moreover, while many aspects and features relate to, and are described in, the context of bookmarks, the present invention is not limited to use only in such contexts, as will become apparent from the following summaries and detailed descriptions of aspects, features, and one or more embodiments of the present invention. Indeed, uses of embodiments of the present invention are not limited to use as bookmarks, and one or more embodiments may not even be usable as bookmarks.

Accordingly, in one aspect of the present invention a toy animal is usable as a stuffed toy animal in a first configuration, and that is transitional to a second configuration in which it is usable as bookmark.

In another aspect, a toy animal comprises atop portion, comprising an upper torso, two limbs, and a head; a bottom portion comprising a lower torso and two limbs; and a connecting portion that extends between and joins the top portion and the bottom portion. The toy animal is transitionable between a first configuration, in which the top portion and the bottom portion are tensioned into abutment with one another, and a second configuration, in which the top portion and the bottom portion are maintained out of abutment with one another.

In a feature, the connecting portion extends in tension between the top portion and the bottom portion.

at distance generally corresponding to a height of a book

In a feature, the two limbs of the top portion comprise arms.

In a feature, the two limbs of the top portion comprise legs.

In a feature, the two limbs of the bottom portion comprise feet.

In a feature, the lower portion further comprises a tail.

In a feature, the top portion and bottom portion together define a complete body of an animal.

In a feature, the connecting portion comprises a band.

In a feature, the connecting portion comprises a ribbon.

In a feature, the connecting portion comprises an elongate, thin extent of material.

In a feature, the connecting portion comprises a strip of non-woven polypropylene and is generally wide, thin and flexible,

In a feature, the connecting portion comprises an elastic strip.

In a feature, the connecting portion has sufficient elasticity to expand a length to extend beyond opposite side edges of a page of a book when in the second configuration, and contract to keep the upper and lower portions of the stuffed toy animal in abutment with one another when in the first configuration.

In a feature, the connecting portion comprises an inelastic strip.

In a feature, the toy animal further comprises a mechanism configured to lock the connecting portion at a particular extension.

In a feature, the toy animal further comprises a hook attached to the back of the top portion whereby the toy animal may be attached to or hung from a child's backpack or other object.

In a feature, the toy animal further comprises hook-and-loop fasteners configured to retain the upper and lower portions in abutment with one another when in the first configuration.

In a feature, the toy animal comprises a stuffed a lion, a chimpanzee, an elephant, dolphin, snow goose, or a polar bear when in the first configuration.

In still another feature of this aspect, one end of the connecting portion is retained within a retractable mechanism that is located within one of the top and bottom portions, and the other end of the connecting portion is affixed to the other of the top and bottom portions. In additional features thereof, the connecting portion may be retractable within the retractable mechanism; the connecting portion may be spring-biased toward retraction into the retractable mechanism; the retractable mechanism may serves to keep the top and bottom portions maintained in abutment with one another; the connecting portion may be elastic; and the connecting portion may be inelastic.

In another aspect, a method of bookmarking a place in a book, comprising the steps of: positioning a top portion of a toy animal on a first side of the book; positioning a bottom portion of the toy animal on a second, opposite side of the book; positioning a connecting portion that joins the top and bottom portions of the toy animal in-between two adjacent pages of the book; and urging the top and bottom portions into abutment with the opposite sides of the book through tension in the connecting portion.

In a feature of this aspect, the method further includes retracting the connecting portion within a mechanism located within one of the top and bottom portions.

In another aspect, the combination of a book and bookmark includes: a book; and a bookmark indicating a location between adjacent pages of the book. The bookmark in turn includes a top portion of a toy animal, a bottom portion of a toy animal, and a connecting portion that extends in-between the adjacent pages of the book and joins the top portion and the bottom portion and maintains the top portion in tensioned abutment with a first side of the book and maintains the bottom portion in tensioned abutment with a second, opposite side of the book.

In a feature, the top portion of the toy animal comprises an upper torso, two limbs, and a head.

In a feature, the bottom portion of the toy animal comprises a lower torso and two limbs.

In addition to the aforementioned aspects and features of the present invention, it should be noted that the present invention further encompasses the various possible combinations and subcombinations of such aspects and features. Thus, for example, any aspect may be combined with an aforementioned feature in accordance with the present invention without requiring any other aspect or feature.

### BRIEF DESCRIPTION OF THE DRAWINGS

One or more preferred embodiments of the present invention now will be described in detail with reference to the accompanying drawings, wherein the same elements are referred to with the same reference numerals.

FIG. 1 is a front view of a plush bookmark in accordance with a preferred embodiment of the present invention, wherein the plush bookmark is in a configuration for use as a plush toy animal.

FIG. 2 is a side view of the plush bookmark of FIG. 1.

FIG. 3 is a back view of the plush bookmark of FIG. 1.

FIG. 4 is a perspective view of the plush bookmark of FIG. 1 illustrating an initial phase of transforming the plush bookmark into a configuration for use as a bookmark.

FIG. 5 is a perspective view of the plush bookmark of FIG. 1, wherein the plush bookmark is in a configuration for use as a bookmark, with the retractable portion fully extended between the top and bottom portions of the plush toy animal's body.

FIG. 6 is a perspective view showing the plush toy animal being used to mark a page in a book, wherein the book is open.

FIG. 7 is another perspective view showing the plush toy animal being used to mark a page in a book, wherein the book is closed.

FIG. 8 is a perspective view of a first side of a retractable mechanism used in one or more embodiments of the present invention.

FIG. 9 is a view similar to that of FIG. 8, but including a ruler revealing dimensions of the retractable mechanism.

FIG. 10 is a perspective view of the other side of the retractable mechanism of FIG. 8, wherein the end of the steel spring is visible.

FIG. 11 is a perspective view of another side of the retractable mechanism of FIG. 8 showing the width of the mechanism to be approximately 2.5 cm.

FIG. 12 is a perspective view of the retractable mechanism of FIG. 8 showing the length of a non-woven polypropylene tab of the fabric band to be approximately 2 cm.

FIG. 13 is a perspective view of the retractable mechanism of FIG. 8 showing the width of the non-woven polypropylene tab of the fabric band to be approximately 1 cm.

FIG. 14 is a perspective view of the retractable mechanism of FIG. 8 in which the non-woven polypropylene band is fully extended from the housing of the retractable mechanism and includes a length of approximately 28 cm.

FIGS. 15-19 are schematic illustrations relating to a top cover of a retractable mechanism in accordance with an embodiment of the present invention.

FIGS. 20-24 are schematic illustrations relating to a base cover of a retractable mechanism in accordance with an embodiment of the present invention.

FIGS. 25-26 are schematic illustrations relating to a steel spring of a retractable mechanism in accordance with an embodiment of the present invention.

FIGS. 27-31 are cross-sectional schematic illustrations relating to the retractable mechanism in accordance with an embodiment of the present invention.

FIGS. 32-36 are schematic illustrations relating to the an interior component of a retractable mechanism in accordance with an embodiment of the present invention.

FIG. 37 is a perspective view of six plush bookmarks of the prior art shown laying on top of an opened book.

### DETAILED DESCRIPTION OF ONE OR MORE PREFERRED EMBODIMENTS

As a preliminary matter, it will readily be understood by one having ordinary skill in the relevant art (“Ordinary Artisan”) that the present invention has broad utility and application. As should be understood, any embodiment may incorporate only one or a plurality of the above-disclosed aspects of the invention and may further incorporate only one or a plurality of the above-disclosed features. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term differs in any way from any particular dictionary definition of such term, it is intended that the meaning of the term as understood by the Ordinary Artisan should prevail.

Regarding applicability of 35 U.S.C.§112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one Or more preferred embodiments of the present invention are next described. The following description of one or more preferred embodiments is merely exemplary in nature and is in no way intended to limit the invention, its implementations, or uses.

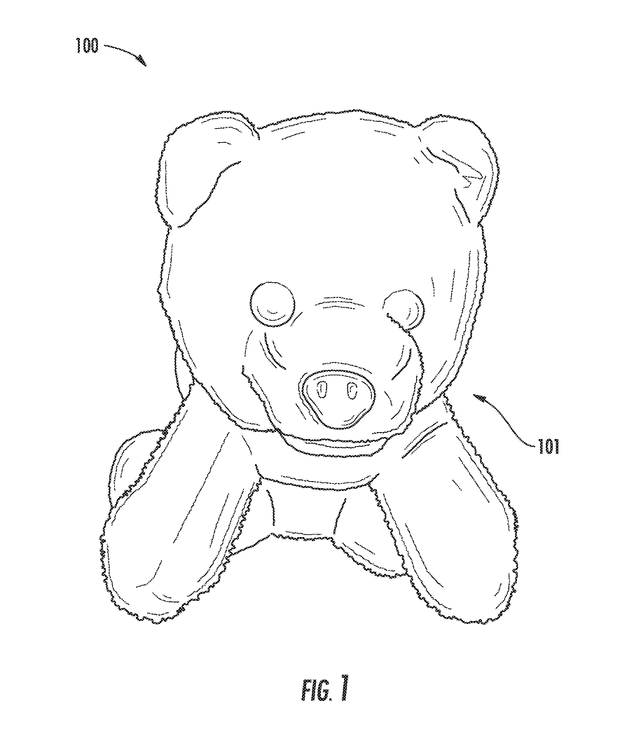

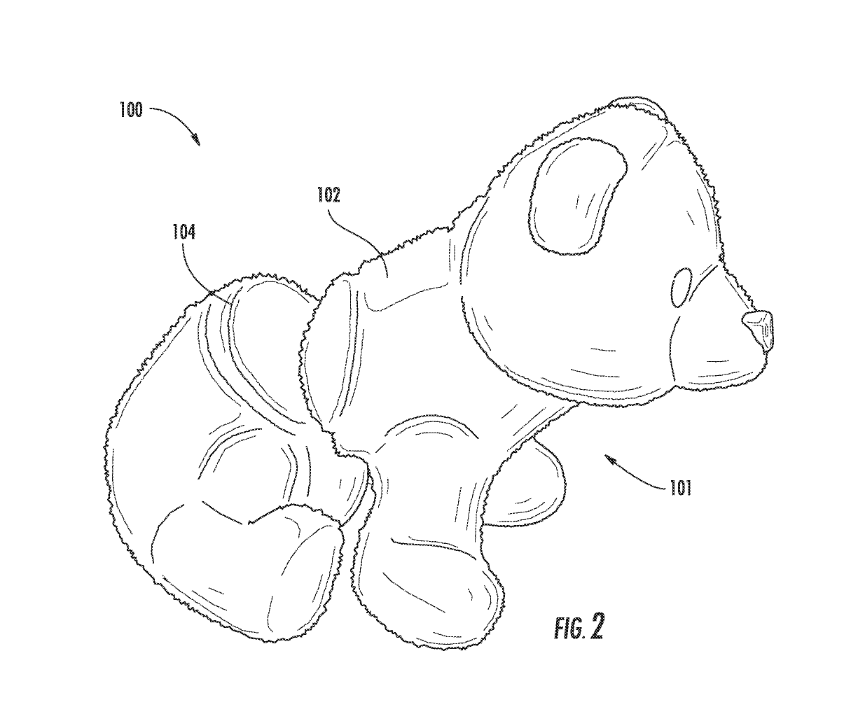

Turning now to the drawings, FIG. 1 is a front view of a plush bookmark 100 in accordance with a preferred embodiment of the present invention, FIG. 2 is a side view thereof, and FIG. 3 is a back view thereof. The plush bookmark 100 is shown in FIGS. 1-3 in a configuration for use as a stuffed toy animal 101. In this respect, a top portion 102 of the stuffed animal and a bottom portion 104 of the stuffed animal are located and maintained together for use of the plush bookmark as a conventional stuffed toy animal. The top portion 102 includes an upper torso, two arms, and a head. The bottom portion 104 comprises a lower torso, two legs, and feet.

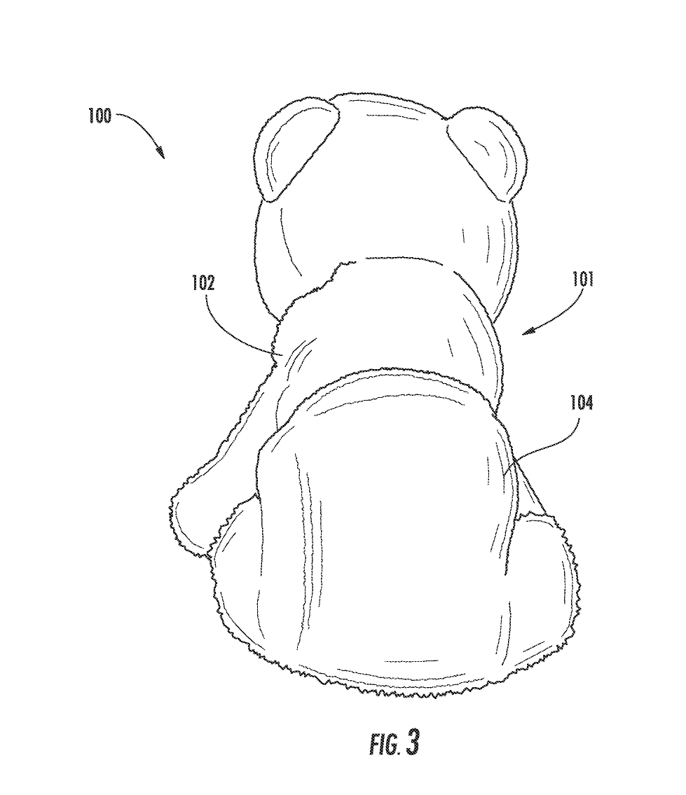

FIG. 4 is a perspective view of the plush bookmark of FIG. 1 illustrating an initial phase of transforming the plush bookmark from a configuration for use as a stuffed toy animal 101 into a configuration for use as a bookmark. In this respect, the top and bottom portions 102,104 are being pulled apart by hand. Moreover, in pulling the top and bottom portions 102,104 apart, a band 106 is revealed that extends between and connects the top and bottom portions 102,104 together. The band 106 comprises non-woven polypropylene and is generally wide, thin and flexible. However, other material may be used for the non-woven band, such as polypropylene and, in some embodiments, a woven band is used instead. One end of the band 106 is retained. within a retractable mechanism that is located within one of the top and bottom portions 102,104, and the other end of the band 106 is affixed to the other of the top and bottom portions 102,104.

As will be described in further detail below, the band 106 is retractable within the retractable mechanism and is spring biased toward retraction into the retractable mechanism. In pulling the top and bottom portions 102,104 apart, a sufficient force is applied by hand to overcome the force of the retractable mechanism. Indeed, when the top and bottom portions 102,104 are joined together, as shown in FIGS. 1-3, this force of the retractable mechanism serves to keep the top and bottom portions 102,104 together and the plush bookmark 100 in the stuffed toy animal configuration 101.

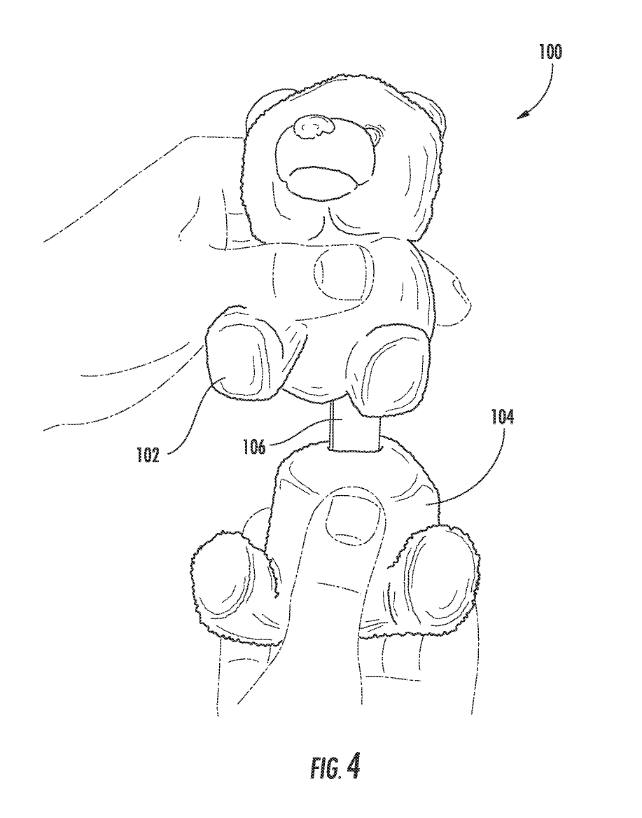

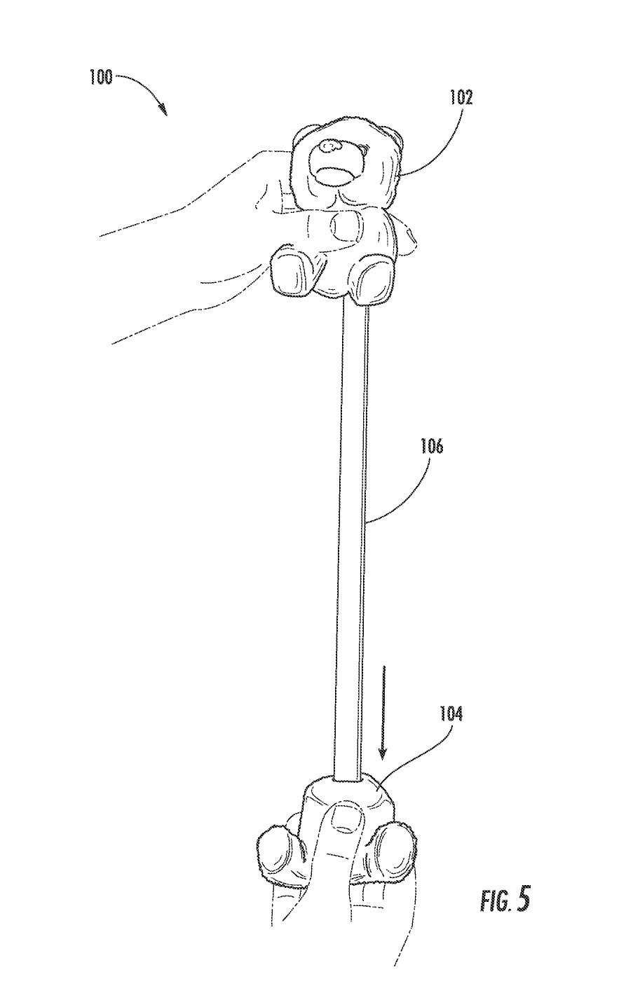

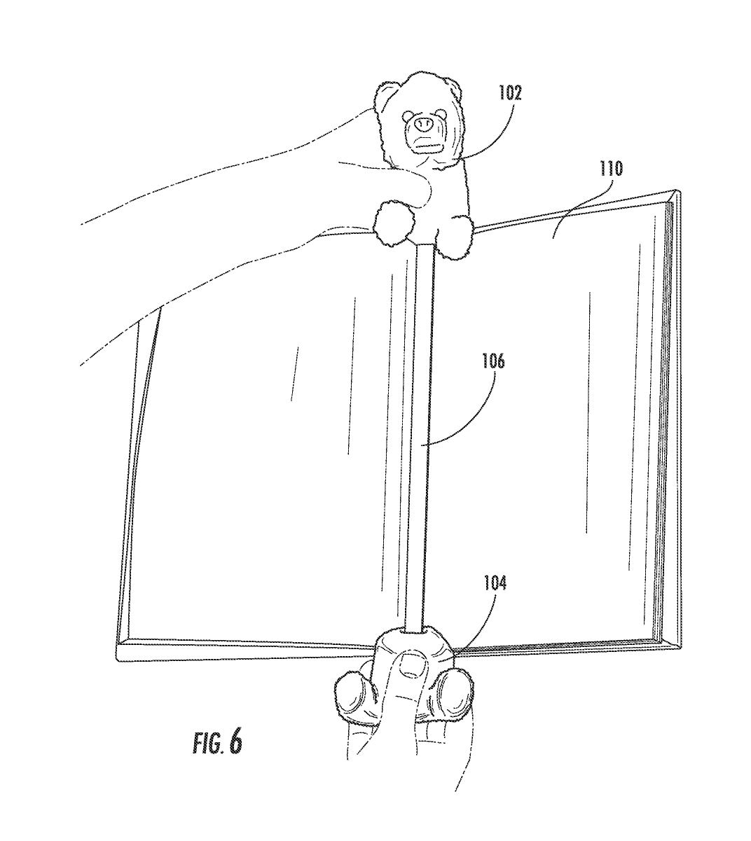

FIG. 5 is a perspective view of the plush bookmark 100 in a configuration for use as a bookmark. As shown in FIG. 5, the band 106 is fully extended and the top and bottom portions 102,104 are located a maximum distance apart. In this state, the bookmark 100 may be positioned such that the top portion 102 extends beyond a first side of an open book 110, the bottom portion 104 extends beyond an opposite second side of the open book 110, and the band 106 extends between two adjacent pages of the open book 110, as illustrated in FIG. 6. By then closing the book 110, the bookmark 100 retains one's place, with the upper portion 102 positioned on the top edge of the book 110 and the lower portion 104 positioned on the bottom edge of the book 110, as shown in FIG. 7.

FIG. 8 is a perspective view of a first side of a retractable mechanism 80 used in the bookmark 100 of FIG. 1-7. FIG. 10 is a perspective view of the other side of the retractable mechanism 80. The retractable mechanism 80 is formed of molded pieces and preferably is formed from an ABS (acrylonitrile butadiene styrene) material having a thickness of 1.5 mm, although other materials and other thicknesses are within the scope of the invention.

An end of a steel spring 86 is visible in FIG. 10 extending through a small opening 88 at a center of the cylindrical portion 82. The small opening 88 generally corresponds to an axis of rotation that occurs within the retractable mechanism 80 during extension and retraction of the band 106.

The retractable mechanism 80 includes a generally cylindrical portion 82. FIG. 9 is a view similar to that of FIG. 8, but includes a ruler revealing dimensions of the retractable mechanism 80 and, specifically, a diameter of the cylindrical shape 82 of approximately 3 cm. The ruler is also illustrated in FIG. 11 and reveals a length of the cylindrical portion 82 of about 2.5 cm.

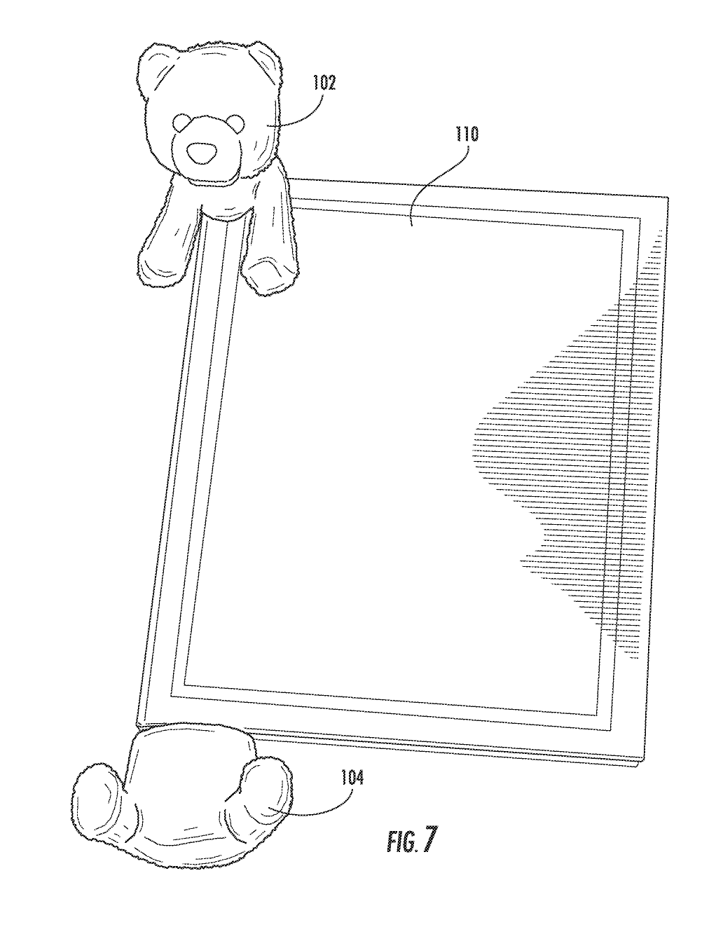

FIGS. 8, 9 and 11-13 each further shows an end of the band 106 in the form of a tab 84. The tab 84 is shaped and dimensioned such that the tab 84 is not retracted within the cylindrical portion 82 and, instead, abuts the cylindrical portion 82 and counteracts the force of retraction that is exerted upon the band 106 within the retractable mechanism 80. The ruler is illustrated in FIG. 12 and reveals a length of the tab 84 to be about 2 cm, and is illustrated in FIG. 13 and reveals a length of the tab 84 to be about 1 cm.

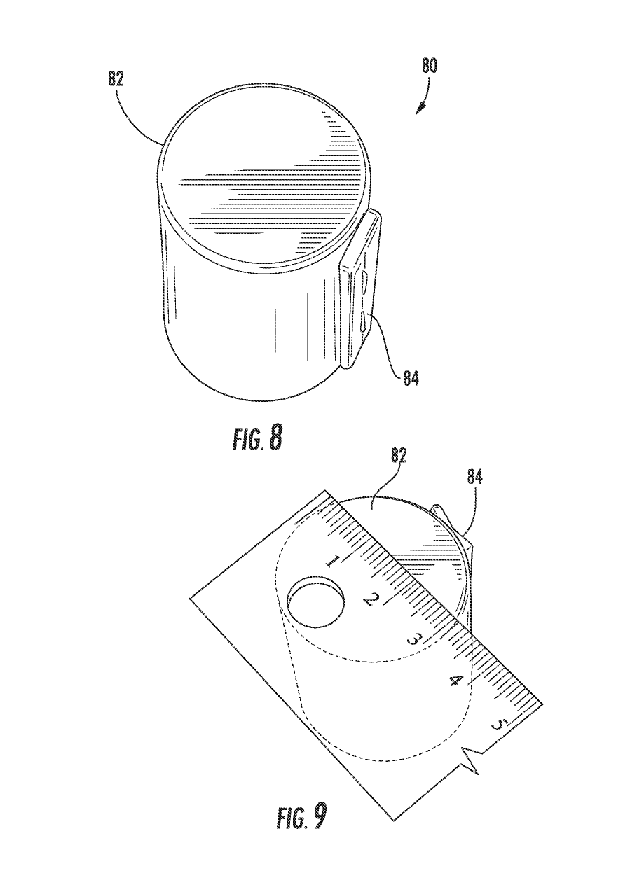

FIG. 14 is a perspective view of the retractable mechanism 80 of FIG. 8, wherein the band 106 is fully extended from the cylindrical portion 82 of the retractable mechanism 80. As shown, the extended portion of the band 106 preferably is about 28 cm in length.

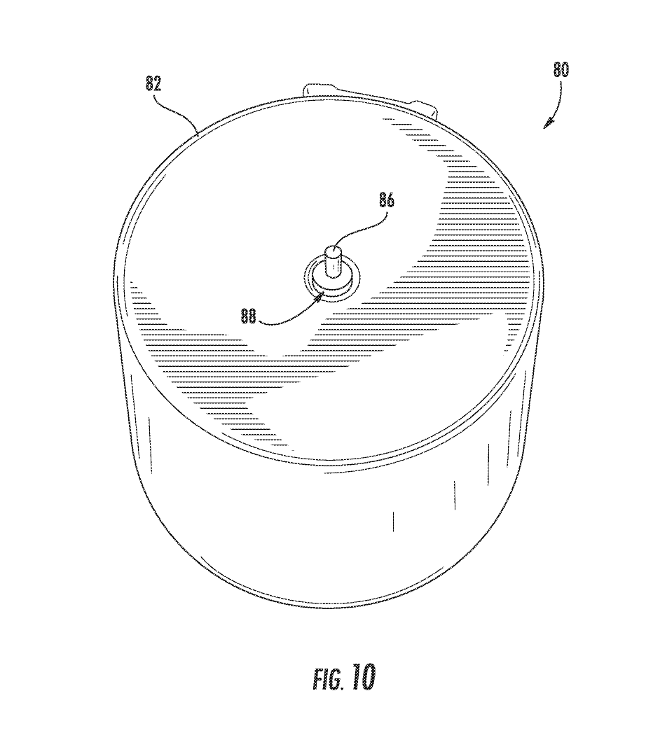

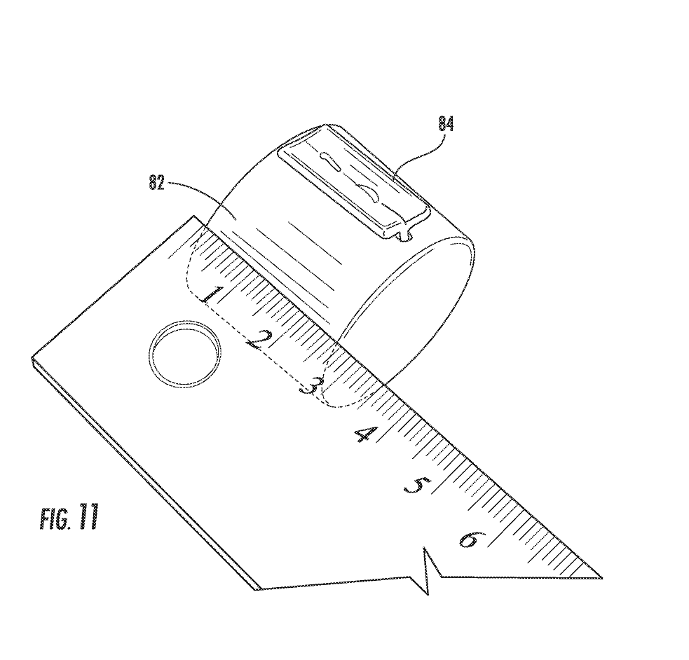

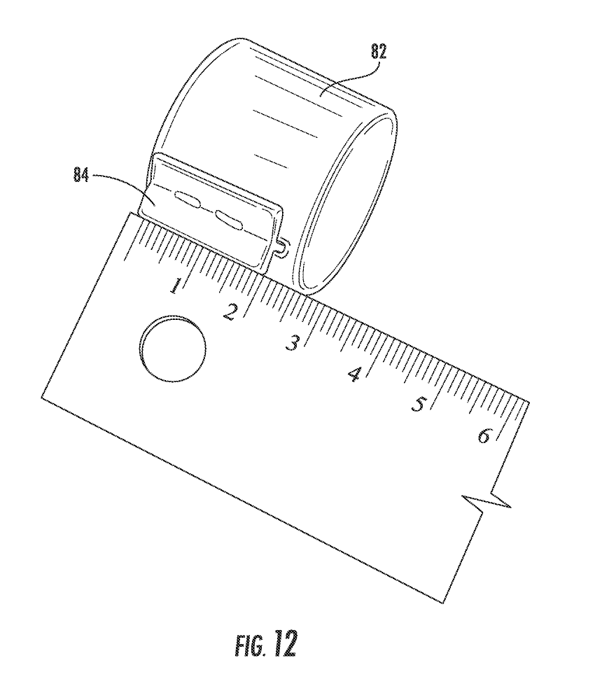

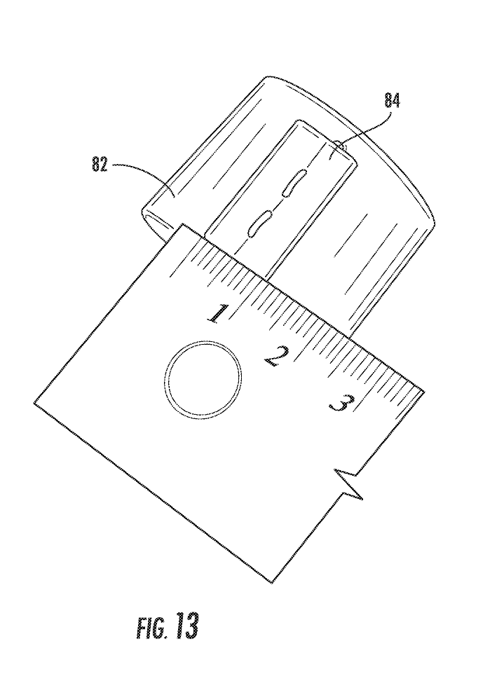

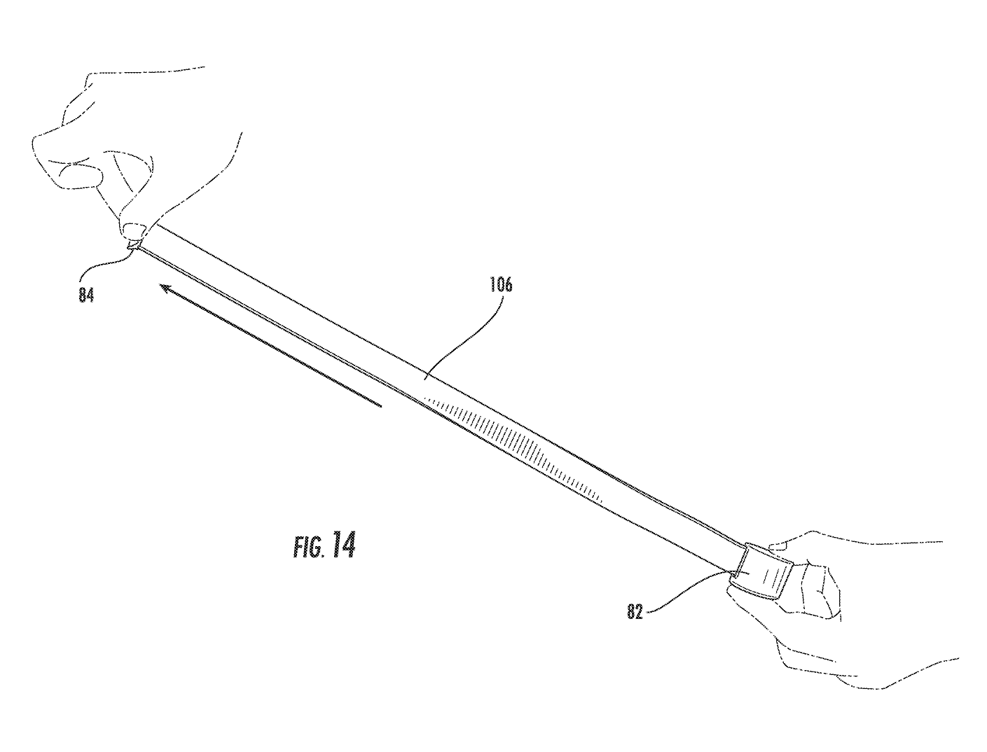

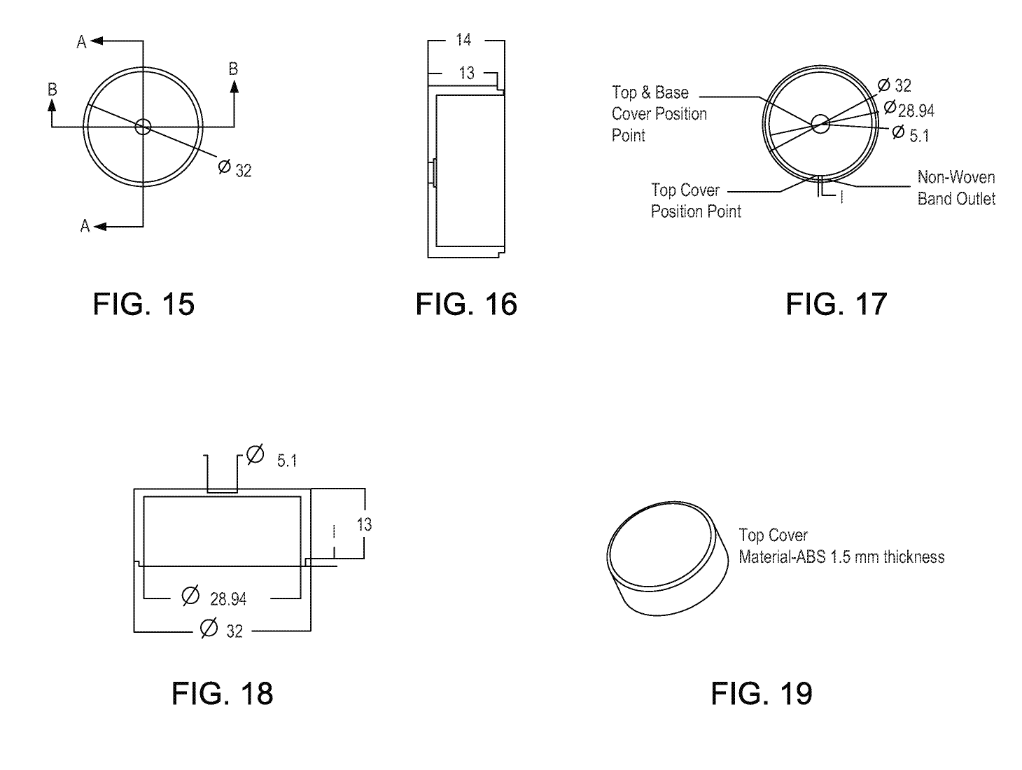

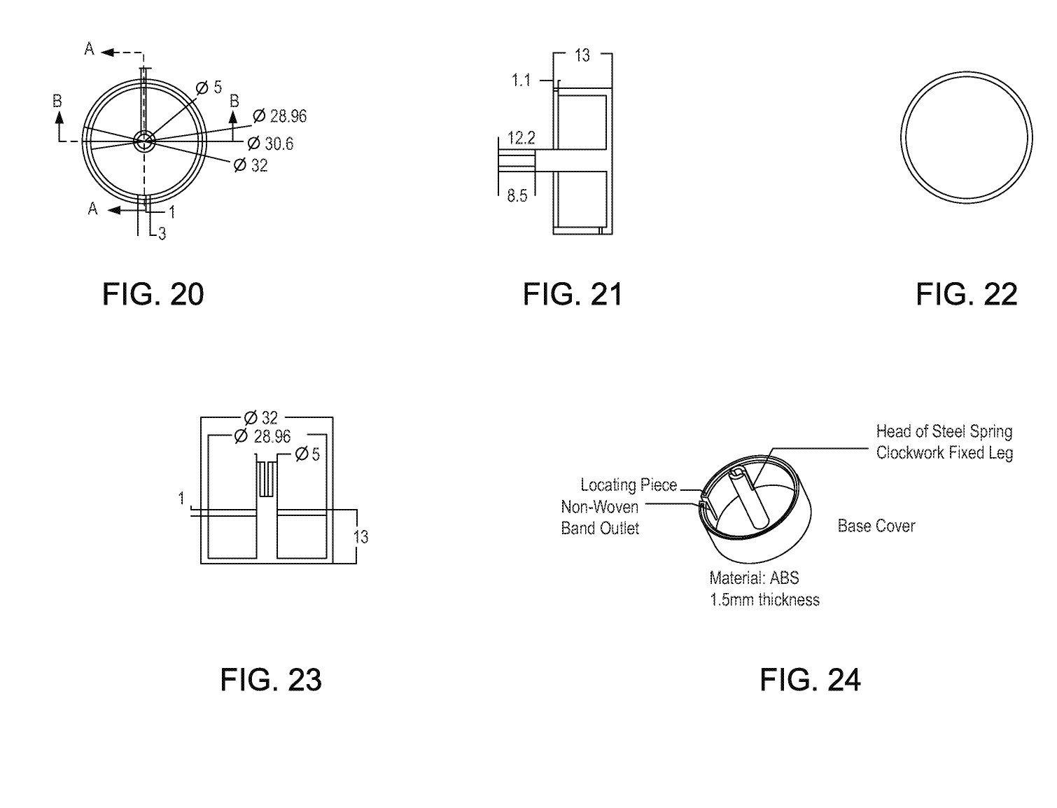

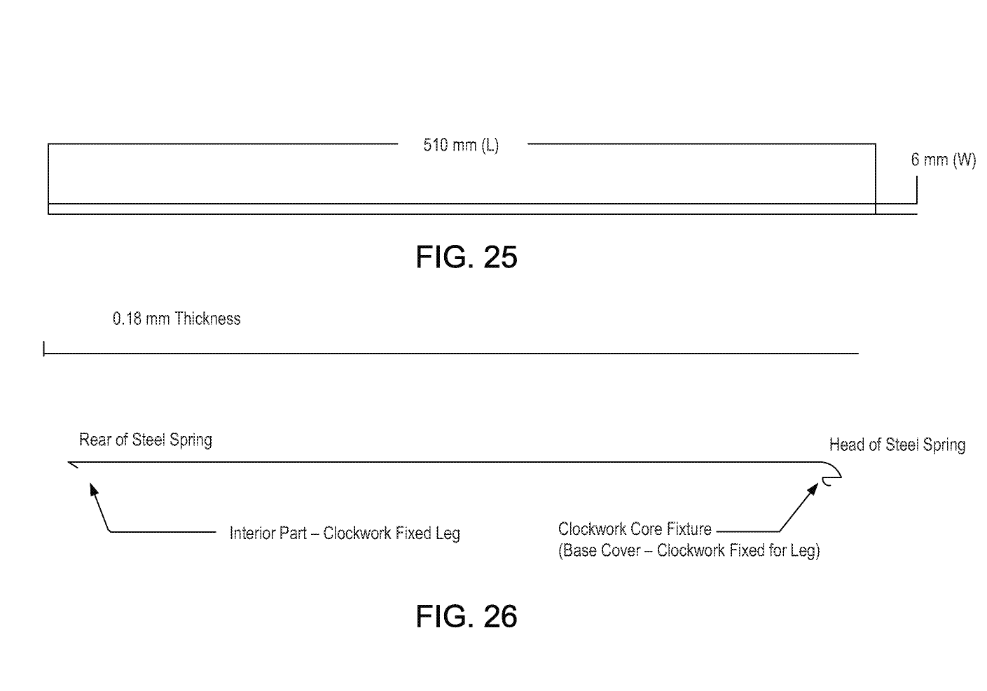

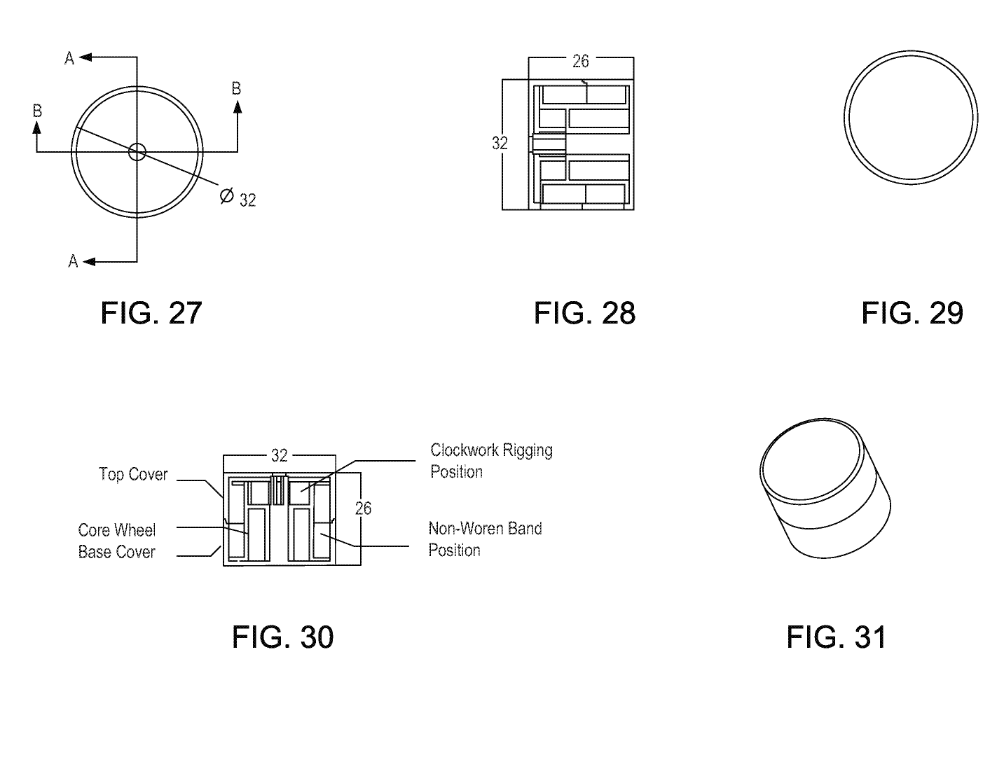

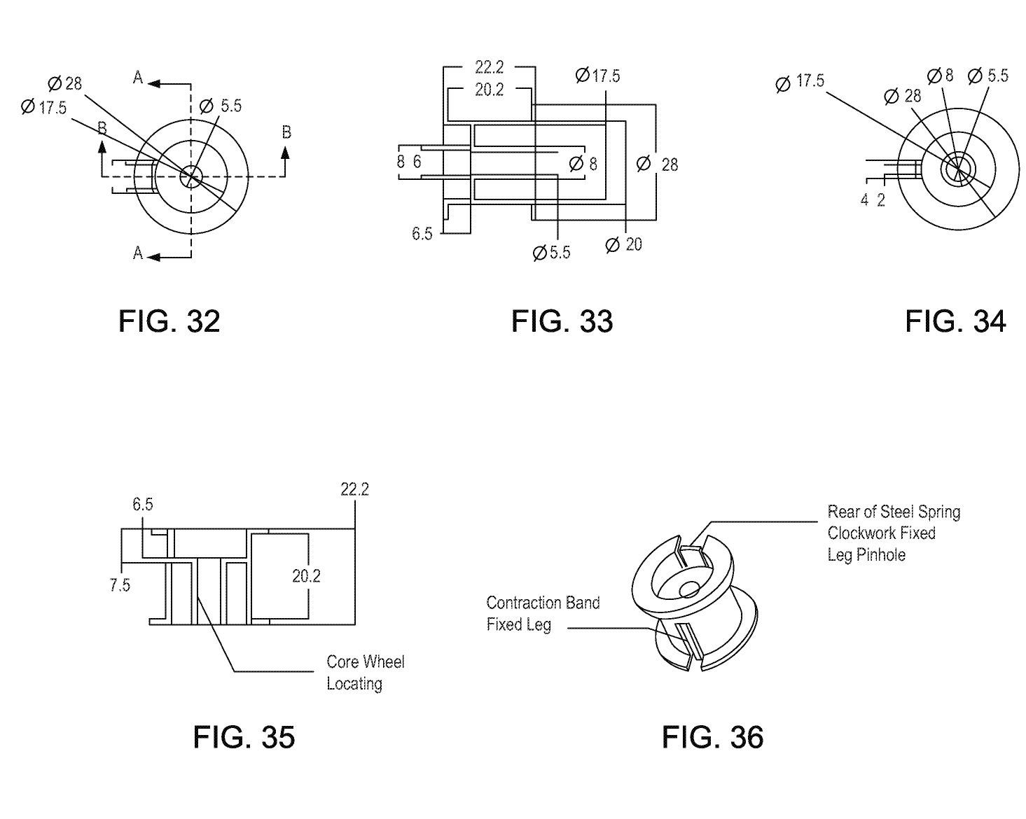

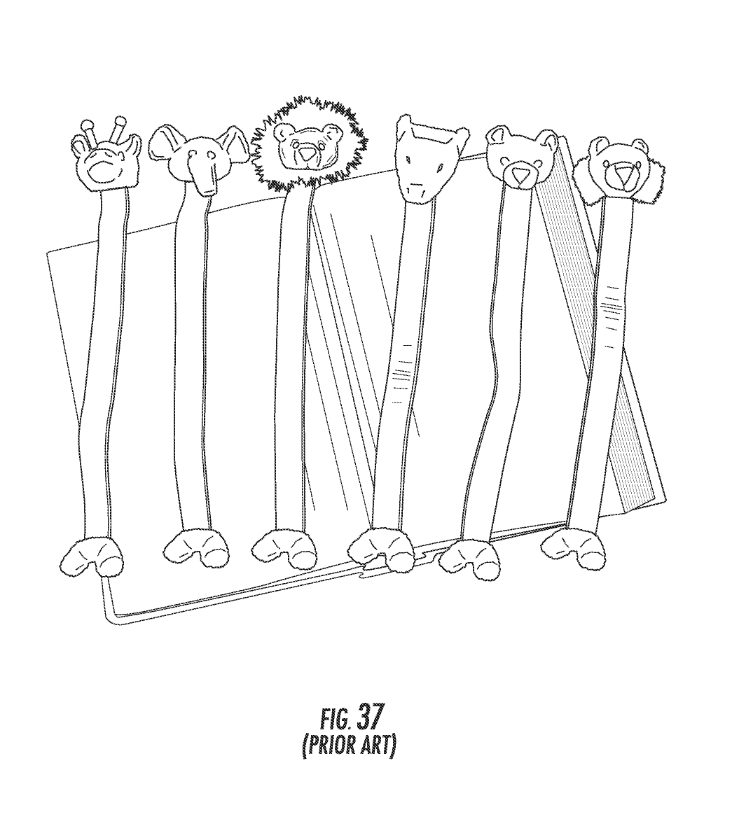

FIGS. 15-19 are schematic illustrations relating to a top cover of the retractable mechanism 80; FIGS. 20-24 are schematic illustrations relating to a base cover of a retractable mechanism 80; FIGS. 25-26 are schematic illustrations relating to a steel spring of a retractable mechanism 80; FIGS. 27-31 are cross-sectional schematic illustrations relating to the retractable mechanism 80; and FIGS. 32-36 are schematic illustrations relating to the an interior component of a retractable mechanism 80.

FIG. 37 is a perspective view of six plush bookmarks of the prior art shown laying on top of an opened book.

While a spring biased retractable mechanism is disclosed in connection with the embodiment shown in the drawings, it is contemplated within the scope of the invention that other ways can be utilized of connecting the top and bottom portions. Thus, for example, an elastic band may be used that has sufficient elasticity in and of itself to expand a sufficient length to be used as a bookmark and contract sufficiently to keep the upper and tower portions of the stuffed toy animal in abutment with one another when it is used as a stuffed toy animal. This is in contract to the band 106 of the drawings, which is flexible but not elastic. Alternatively, a band may be used that is retractable and that is elastic, representing a combination of these two ways. In this alternative, the band may comprises a fabric-covered elastic material.

In another alternative, the top and bottom portions are joined by a ribbon. The ribbon extends in-between adjacent pages of a closed book and joins the top and bottom portions of the stuffed toy animal when used as a bookmark, and the ribbon is folded and stored within a backpack of the upper portion of the stuffed toy animal when uses as a stuffed toy animal. Velcro latches also may be utilized to retain the upper and lower portions of the stuffed toy animal together in this and similar embodiments wherein no force otherwise acts to maintain abutment of the upper and lower portions.

In still a further feature, a mechanism locks the band at an extension similar to how a lockable retractable tape measure works.

In still another feature, a mechanism locks and then unlocks the band at an extension similar to how a retractable blind works.

In an additional feature, a hook is attached to the back of the top portion of the bookmark whereby the bookmark may be attached to or hung from a child's backpack or other object when in the stuffed toy animal configuration, the bookmark configuration, or both.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a lull and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

Thus, while a polar bear is shown in the drawings, the invention is not limited to a plush toy animal that comprises a polar bear. Indeed, many other animals are contemplated, including a lion, a chimpanzee, an elephant, a dolphin, and a snow goose. Any other type of animal is contemplated within the scope of the invention. The size of each animal will vary, but the average size will be about 14 cm in length, about 15 cm in height, and about 6 cm in width.

What is claimed is:

1. A toy animal, comprising:
(a) atop portion, comprising an upper torso, two limbs, and a head;
(b) a bottom portion comprising a lower torso and two limbs; and
(c) a connecting portion that extends between and joins the top portion and the bottom portion;
(d) wherein toy animal is transitionable between a first configuration, which the top portion and the bottom portion are tensioned into abutment with one another, and a second configuration, in which the top portion and the bottom portion are maintained out of abutment with one another.

2. The toy animal of claim 1, wherein the connecting portion extends in tension between the top portion and the bottom portion.

3. The toy animal of claim 1, wherein the top portion and bottom portion together define a complete body of an animal.

4. The toy animal of claim 1, wherein the connecting portion comprises an elongate, thin extent of material.

5. The toy animal of claim 1, wherein the connecting portion has sufficient elasticity to expand a length to extend beyond opposite side edges of a page of a book when in the second configuration, and contract to keep the upper and lower portions of the stuffed toy animal in abutment with one another when in the first configuration.

6. The toy animal of claim 1, wherein the connecting portion is generally inelastic.

7. The toy animal of claim 1, wherein one end of the connecting portion is retained within a retractable mechanism that is located within one of the top and bottom portions, and the other end of the connecting portion is affixed to the other of the top and bottom portions.

8. The toy animal of claim 7, wherein the connecting portion is retractable within the retractable mechanism.

9. The toy animal of claim 7, wherein the connecting portion is spring-biased toward retraction into the retractable mechanism.

10. The toy animal of claim 9, wherein the retractable mechanism serves to keep the top and bottom portions maintained in abutment with one another.

11. The toy animal of claim 1, further comprising a mechanism configured to lock the connecting portion at a particular extension.

12. The toy animal of claim 1, further comprising a hook attached to the back of the top portion whereby the toy animal may be attached to or hung from a child's backpack or other object.

13. The toy animal of claim 1, further comprising hook-and-loop fasteners configured to retain the upper and lower portions in abutment with one another when in the first configuration.

14. A method of bookmarking a place in a book, comprising:
(a) positioning a top portion of a toy animal on a first side of the book;
(b) positioning a bottom portion of the toy animal on a second, opposite side of the book;
(c) positioning a connecting portion that joins the top and bottom portions of the toy animal in-between two adjacent pages of the book; and
(d) urging the top and bottom portions into abutment with the opposite sides of the book through tension in the connecting portion.

15. The method of claim 14, further comprising retracting the connecting portion within a mechanism located within one of the top and bottom portions.

16. The combination of a book and bookmark, comprising:
(a) a book; and
(b) a bookmark indicating a location between adjacent pages of the book, wherein the bookmark comprises,
(i) a top portion of a toy animal,
(ii) a bottom portion of a toy animal, and
(iii) a connecting portion that extends in-between the adjacent pages of the book and joins the top portion and the bottom portion and maintains the top portion in tensioned abutment with a first side of the book and maintains the bottom portion in tensioned abutment with a second, opposite side of the book.

17. The combination of a book and a bookmark of claim 16, wherein the top portion of the toy animal comprises an upper torso, two limbs, and a head.

18. The combination of a book and a bookmark of claim 17, wherein the bottom portion of the toy animal comprises a lower torso and two limbs.

19. The combination of a book and a bookmark of claim 17, wherein the connecting portion extends a length that corresponds to a height of the book.

20. The combination of a book and a bookmark of claim 17, wherein the connecting portion maintains the top portion in tensioned abutment with the bottom portion when the bookmark is removed from the book.
